(19) United States
(12) Patent Application Publication
(10) Pub. No.: US 2026/0103355 A1
(43) Pub. Date: Apr. 16, 2026

(54) IMAGE FORMING APPARATUS

(71) Applicant: KYOCERA Document Solutions Inc., Osaka (JP)

(72) Inventors: Akira ISHII, Osaka (JP); Takafumi SHIBUYA, Osaka (JP); Minoru SHINBA, Osaka (JP)

(73) Assignee: KYOCERA Document Solutions Inc., Osaka (JP)

(21) Appl. No.: 19/348,261

(22) Filed: Oct. 2, 2025

(30) Foreign Application Priority Data
Oct. 15, 2024 (JP) 2024-179905

(51) Int. Cl. B65H 3/06; B65H 5/06; G03G 15/00

(52) U.S. Cl. CPC B65H 3/0638; B65H 5/068; G03G 15/6502; B65H 2402/44; B65H 2404/14; B65H 2404/5331; B65H 2801/15

(57) ABSTRACT

An image forming apparatus includes an image forming portion and a sheet feed unit. The sheet feed unit has a pickup roller, a feed roller, and a retard roller. The pickup roller makes contact with a recording medium stored in a sheet feed cassette and feeds out the recording medium. The feed roller conveys the recording medium fed out by the pickup roller. The retard roller is kept in pressed contact with the feed roller to form a nip portion and conveys the recording medium while separating one sheet of it from the rest. The feed roller is covered at least partly from above by a first charge elimination member. The first charge elimination member is grounded.

### INCORPORATION BY REFERENCE

This application is based on and claims the benefit of priority from Japanese Patent Application No. 2024-179905 filed on October 15, 2024, the contents of which are hereby incorporated by reference.

### BACKGROUND

The present disclosure relates to electrophotographic type image forming apparatuses such as copiers, printers, facsimile machines, and multifunction peripherals having their functions integrated together.

Conventional image forming apparatuses include an image forming portion and a sheet feed unit. The image forming portion forms an image on a recording medium. The sheet feed unit feeds the recording medium to the image forming portion. The sheet feed unit has a pickup rocker, a feed roller, and a retard roller. The pickup roller makes contact with the recording medium stored in a sheet feed cassette and feeds out the recording medium. The feed roller conveys the recording medium fed out by the pickup roller. The retard roller is kept in pressed contact with the feed roller to form a nip portion and conveys the recording medium while separating one sheet of it from the rest.

Downstream of the retard roller, a charge elimination member is arranged in a sheet conveyance passage. Thus, the recording medium electrostatically charged when passing through the retard roller has the electric charge on it eliminated by making contact with the charge elimination member. This makes it easy for the recording medium to peel off the retard roller and this helps reduce sheet feed failure.

In conventional image forming apparatuses, when the recording medium is fed at high speed, or the material of the retard roller is changed, or the type of recording medium is changed, the amount of charge on the recording medium may increase due to friction with the retard roller. In that case, the charge current flowing from the charge elimination member arranged in the sheet conveyance passage to the ground increases, so the supply voltage level in the apparatus may vary. This may lead to operation failure of circuit boards and sensors arranged near the sheet conveyance passage.

An object of the present disclosure is to provide an image forming apparatus that can reduce sheet feed failure while preventing operation failure.

### SUMMARY

To achieve the above object, according to one aspect of the present disclosure, an image forming apparatus includes an image forming portion and a sheet feed unit. The image forming portion forms an image on a recording medium. The sheet feed unit feeds the recording medium to the image forming portion. The sheet feed unit has a pickup roller, a feed roller, and a retard roller. The pickup roller makes contact with a recording medium stored in a sheet feed cassette and feeds out the recording medium. The feed roller conveys the recording medium fed out by the pickup roller. The retard roller is kept in pressed contact with the feed roller to form a nip portion and conveys the recording medium while separating one sheet of it from the rest. The feed roller is covered at least partly from above by a first charge elimination member. The first charge elimination member is grounded.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic sectional view showing the overall structure of an image forming apparatus 100 according to a first embodiment of the present disclosure.

FIG. 2 is a perspective view of a sheet feed unit 60 in the image forming apparatus 100 according to the first embodiment of the preset disclosure.

FIG. 3 is an enlarged sectional part view of the sheet feed unit 60 in the image forming apparatus 100 according to the first embodiment of the preset disclosure

FIG. 4 is an enlarged sectional part view of a sheet feed unit 60 in the image forming apparatus 100 according to a second embodiment of the preset disclosure.

### DETAILED DESCRIPTION

### First Embodiment

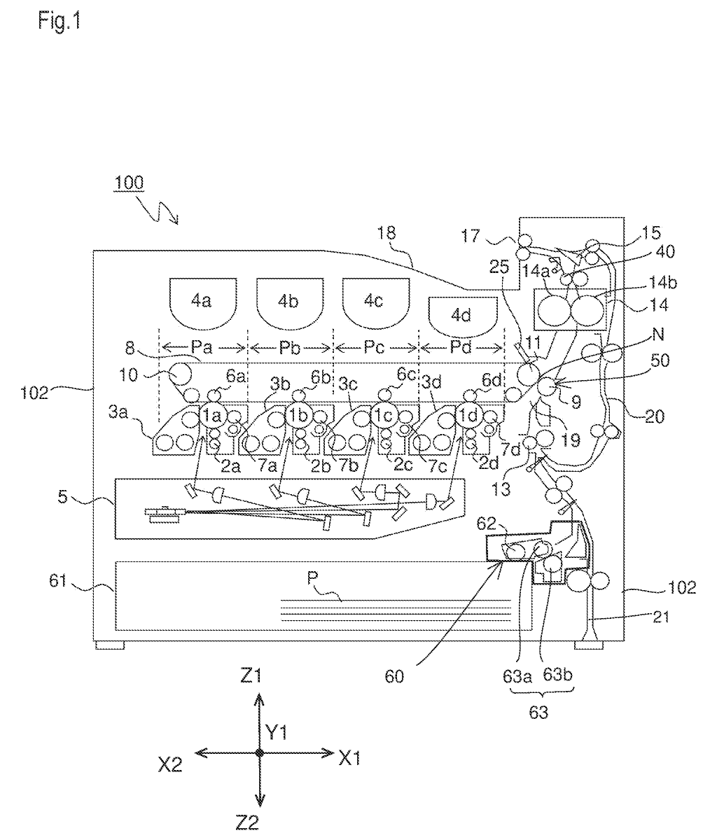

An embodiment of the present disclosure will be described with reference to the drawings. FIG. 1 is a sectional view showing the internal structure of an image forming apparatus 100 according to a first embodiment of the present disclosure. For convenience’ sake, the vertical direction in an installed state (the state shown in FIG. 1) in which the image forming apparatus 100 is ready for use is defined as the up-down direction (Z1-Z2). The front-rear direction (Y1-Y2) is defined with the near-side face of the image forming apparatus 100 in the plane of in FIG. 1 as the front face. The left-right direction (X1-X2) is defined with respect to the front face of the image forming apparatus 100 in the installed state. In this embodiment, the left-right direction (X1-X2) is orthogonal to the up-down direction (Z1-Z2) and to the front-rear direction (Y1-Y2). The left-right direction (X1-X2) is taken as the facing direction in which a pair of side faces of the image forming apparatus 100 face each other and the front-rear direction (Y1-Y2) is taken as the axial direction of a feed roller 63a. Note that the definition of the up-down direction is not meant to limit any directions or positional relationships as observed during the use of the image forming apparatus 100.

The image forming apparatus 100 includes image forming portions Pa to Pd, a sheet feed unit 60, a transfer portion 50, a fixing portion 14, a discharge portion 17, a pair of conveyance rollers 40, a sheet conveyance passage 19, and a branch conveyance passage 20.

In a main body of the image forming apparatus 100 (here, a color printer), four image forming portions Pa, Pb, Pc, and Pd are arranged in this order from upstream (the left side in FIG. 1) in the conveyance direction. The image forming portions Pa to Pd form images on a transfer sheet (recording medium) P.

More specifically, the image forming portions Pa to Pd are provided so as to correspond to images of four different colors (yellow, cyan, magenta, and black). The image forming portions Pa to Pd form yellow, cyan, magenta, and black images sequentially, each through the processes of electrostatic charging, exposure to light, image development, and image transfer.

The image forming portions Pa to Pd form visible images (toner images) of the different colors on photosensitive drums (image carrying members) 1a to 1d. An intermediate transfer belt (intermediate transfer member) 8 that rotates counterclockwise in FIG. 1 is provided adjacent to the image forming portions Pa to Pd. The toner images formed on the photosensitive drums 1a to 1d are primarily transferred sequentially to, so as to be overlaid on each other on, the intermediate transfer belt 8, which moves while in contact with the photosensitive drums 1a to 1d.

The transfer portion 50 transfers the toner images formed in the image forming portions Pa to Pd to the transfer sheet P (recording medium). The transfer portion 50 has a driving roller 11 and a secondary transfer roller 9. Specifically, the toner images primarily transferred to the intermediate transfer belt 8 are secondarily transferred by the secondary transfer roller 9 to the transfer sheet P as one example of a recording medium. The transfer sheet P having the toner images secondarily transferred to it has the toner image fixed to it in the fixing portion 14, and is then discharged out of the main body of the image forming apparatus 100.

The sheet feed unit 60 feeds the transfer sheet P to the image forming portions Pa to Pd. Specifically, the sheet feed unit 60 has a pickup roller 62, a feed roller 63a, and a retard roller 63b. The sheet feed unit 60 is arranged above Z1 a sheet cassette 61. The sheet cassette 61 is arranged in a bottom part of the main body of the image forming apparatus 100 and stores the transfer sheet P to which the toner images are to be secondarily transferred.

The pickup roller 62 is kept in pressed contact with the top face of the transfer sheet P with a predetermined pressure. Rotating the pickup roller 62 starts the feeding of the transfer sheet P. That is, the pickup roller 62 makes contact with the transfer sheet (recording medium) P stored in the sheet cassette 61 and feeds out the transfer sheet (recording medium) P to the sheet conveyance passage 19.

The feed roller 63a and the retard roller 63b constitute a pair of feeding rollers 63. The feed roller 63a conveys the transfer sheet (recording medium) P fed out from the pickup roller 62. The retard roller 63b is kept in pressed contact with the feed roller 63a to form a nip portion and conveys the transfer sheet (recording medium) P while separating one sheet of it from the rest.

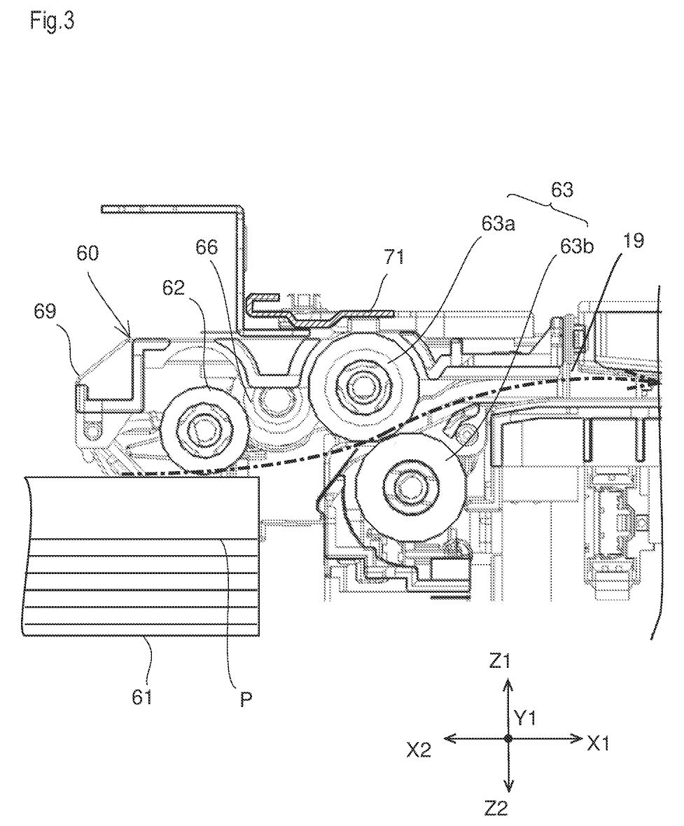

Specifically, the retard roller 63b is kept in pressed contact with and rotates by following the feed roller 63a. The retard roller 63b incorporates a torque limiter. Between the feed roller 63a and the pickup roller 62 is arranged a driving force transmission gear 66 that transmits the rotation of the feed roller 63a to the pickup roller 62 (see FIG. 3).

Thus, if a plurality of transfer sheets P are fed at the same time by the pickup roller 62, the feed roller 63a and the retard roller 63b separate the transfer sheets P so as to pick out and feed only the topmost sheet to the sheet conveyance passage 19. The transfer sheet P having passed through the sheet conveyance passage 19 reaches a pair of registration rollers 13 and is conveyed to the nip portion between the secondary transfer roller 9 and the driving roller 11 of the intermediate transfer belt 8 in time for image formation. The sheet feed unit 60 will be described in detail later.

Used as the intermediate transfer belt 8 is a sheet of dielectric resin, which typically is a belt without a seam (seamless belt). A blade-form belt cleaner 25 for removing toner and the like remaining on the surface of the intermediate transfer belt 8 is arranged downstream of the secondary transfer roller 9.

Around and below the photosensitive drums 1a to 1d, which are rotatably arranged, there are provided charging devices 2a, 2b, 2c, and 2d, an exposure device 5, development devices 3a, 3b, 3c, and 3d, and cleaning devices 7a, 7b, 7c, and 7d. The charging devices 2a, 2b, 2c, and 2d electrostatically charge the photosensitive drums 1a to 1d. The exposure device 5 shines light carrying image information onto the photosensitive drums 1a to 1d. The development devices 3a, 3b, 3c, and 3d form toner images on the photosensitive drums 1a to 1d. The cleaning devices 7a, 7b, 7c, and 7d remove the developer (toner) and the like remaining on the photosensitive drums 1a to 1d.

When image data is fed in from a host device such as a personal computer, first, the charging devices 2a to 2d electrostatically charge the surfaces of the photosensitive drums 1a to 1d uniformly. Next, the exposure device 5 irradiates the photosensitive drums 1a to 1d with light according to image data to form on them electrostatic latent images according to the image data. The development devices 3a to 3d are loaded with predetermined amounts of two-component developer containing toner of different colors, namely yellow, cyan, magenta, and black respectively. When, as image formation proceeds and the proportion of the toner in the two-component developer in the development devices 3a to 3d falls below a prescribed value, toner is supplied from toner containers 4a to 4d to the development devices 3a to 3d.

The toner in the developer is fed from the development devices 3a to 3d to the photosensitive drums 1a to 1d and electrostatically adheres to them. Thus, toner images are formed according to the electrostatic latent images formed by exposure to light from the exposure device 5.

Then, primary transfer rollers 6a to 6d produce electric fields at a predetermined transfer voltage between the primary transfer rollers 6a to 6d and the photosensitive drums 1a to 1d, and thereby the yellow, cyan, magenta, and black toner images on the photosensitive drums 1a to 1d are primarily transferred to the intermediate transfer belt 8. These images are formed in a predetermined positional relationship. After that, in preparation for the subsequent formation of new electrostatic latent images, the toner and the like remaining on the surfaces of photosensitive drums 1a to 1d after primary transfer are removed by the cleaning devices 7a to 7d.

The intermediate transfer belt 8 is wound around a driven roller 10, arranged upstream, and the driving roller 11, arranged downstream. As the driving roller 11 is rotated by a belt driving motor (not illustrated), the intermediate transfer belt 8 starts rotating counterclockwise, and the transfer sheet P is conveyed with predetermined timing from the pair of registration rollers 13 to a secondary transfer nip portion N between the driving roller 11 and the secondary transfer roller 9 provided next to it. The toner images formed on the intermediate transfer belt 8 are secondarily transferred to the transfer sheet P passing through the secondary transfer nip portion N.

The transfer sheet P having the toner images secondarily transferred to it is conveyed to the fixing portion 14. The fixing portion 14 has a fixing belt 14a and a pressing roller 14b. The fixing belt 14a is heated with a heating device such as a heater or an induction heating portion (not illustrated). The pressing roller 14b is kept in pressed contact with the fixing belt 14a to form a fixing nip and applies a rotational driving force to the fixing belt 14a.

The transfer sheet P conveyed to the fixing portion 14 is heated and pressed by the fixing belt 14a and the pressing roller 14b, so that the toner images are fixed to the surface of the transfer sheet P to form a predetermined full-color image.

The transfer sheet P with the full-color image formed on it is conveyed via the pair of conveyance rollers 40 and then has its conveyance direction switched by a conveyance guide member 15 arranged in a branching portion of the sheet conveyance passage 19 so as to be discharged as it is (or after being diverted to a branch conveyance passage 20 to have images formed on both sides) to a discharge tray 18 by a pair of discharge rollers (discharge portion) 17.

The pair of conveyance rollers 40 feeds out the transfer sheet (recording medium) P from the fixing portion 14 to the pair of discharge rollers (discharge portion) 17.

The sheet conveyance passage 19 connects together the sheet feed unit 60, the transfer portion 50, the fixing portion 14, and the discharge portion 17. The branch conveyance passage 20 branches off the sheet conveyance passage 19 downstream of the pair of conveyance rollers 40 and communicates with the sheet conveyance passage 19 upstream of the pair of registration rollers 13. The branch conveyance passage 20 extends in the up-down direction (Z1-Z2) along a side face 102 of the image forming apparatus 100 and curves substantially in a C-shape.

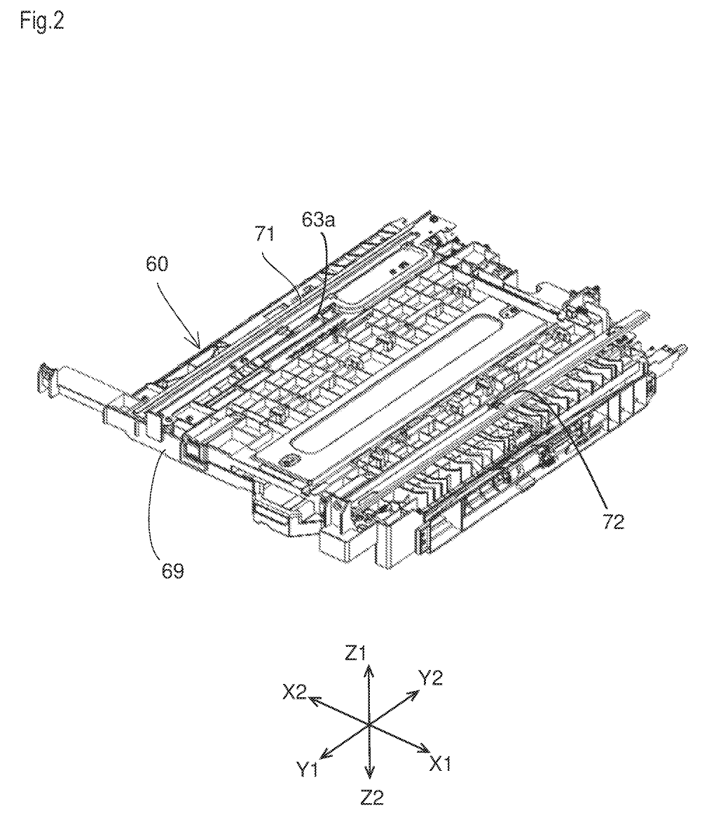

FIG. 2 is a perspective view of a sheet feed unit 60 and FIG. 3 is an enlarged sectional part view of the sheet feed unit 60. In FIG. 3, the conveyance direction of the transfer sheet P is indicated by a dash-and-dot line.

The sheet feed unit 60 further includes a housing 69 that holds the pickup roller 62, the feed roller 63a, and the retard roller 63b. The sheet feed unit 60 constitutes part of the conveyance face of sheet conveyance passage 19. The sheet feed unit 60 is attachable to the apparatus main body of the image forming apparatus 100 along guide rails 71 and 72 arranged in the housing 69.

The guide rails 71 and 72 are made of sheet metal and are electrically conductive. In this embodiment, the guide rails 71 and 72 extend parallel to the axial direction (Y1-Y2) of the feed roller 63a. The guide rail 71 serves as a first charge elimination member and covers the feed roller 63a at least partly from above. That is, the feed roller 63a is covered at least partly from above by the guide rail (first charge elimination member) 71.

While, in this embodiment, the guide rail 71 is made of sheet metal, it can instead be a molding of resin as long as an electrically conductive member is arranged on its surface facing the feed roller 63a.

The guide rail 71 is grounded to the ground via the main body frame of the image forming apparatus 100. As a result, the electric charge on the transfer sheet P electrostatically charged by friction with the feed roller 63a is eliminated via the feed roller 63a and the guide rail 71. This reduces the amount of charge on the transfer sheet P passing through the feed roller 63a and makes it easy for the transfer sheet P to peel off the feed roller 63a. This helps reduce sheet feed failure. The guide rail (first charge elimination member) 71 is arranged outside the sheet conveyance passage 19 and the charge current passes via a position away from the sheet conveyance passage 19. This prevents malfunctioning of circuit boards and sensors arranged near the sheet conveyance passage 19 and reduces operation failure in the apparatus.

The first charge elimination member is configured as the guide rail 71 and so, without increasing the number of the components of the sheet feed unit 60, it is possible to eliminate the charge on the transfer sheet P. It is thus possible to suppress an increase in the manufacturing cost of the sheet feed unit 60.

The guide rail 71 has a length in the axial direction (Y1-Y2) greater than the axial length of the feed roller 63a. Thus, the electric charge on the electrostatically charged transfer sheet P can be efficiently eliminated via the feed roller 63a and the guide rail 71.

In this embodiment, the feed roller 63a and the guide rail (first charge elimination member) 71 face each other across a gap of 2.5 mm, and the gap is preferably 2 mm or more but 4 mm or less. If the gap is smaller than 2 mm, the feed roller 63a and the guide rail 71 may come into contact with each other. If the gap is larger than 4 mm, the effect of charge elimination is low.

The guide rail (first charge elimination member) 71 curves along the feed roller 63a to be convex outward in the radial direction. This makes it possible to secure a large region over which the guide rail (first charge elimination member) 71 and the feed roller 63a face each other at an even distance in the radial direction. This helps enhance the effect of eliminating the charge.

### Second Embodiment

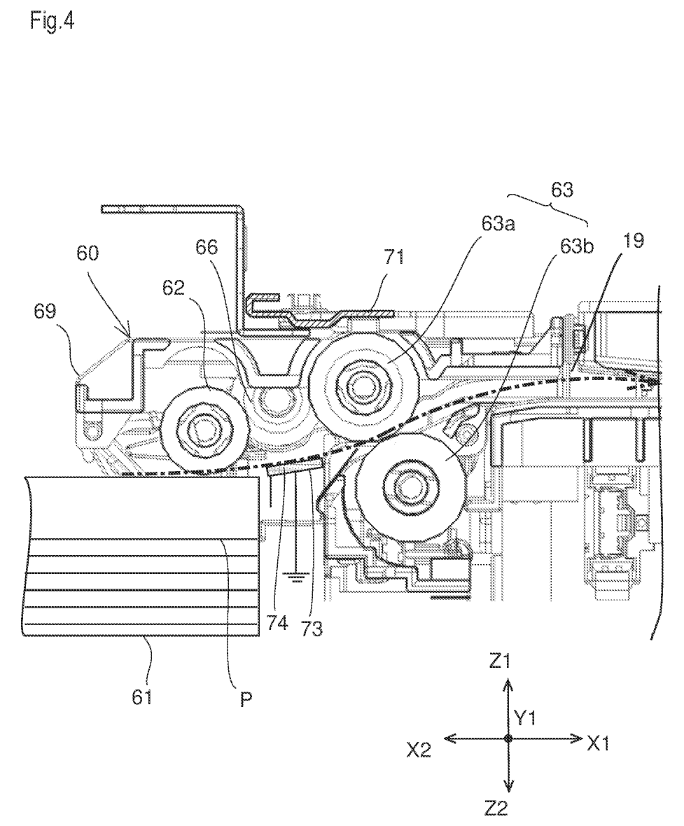

Next, a second embodiment of the present disclosure will be described. FIG. 4 is an enlarged sectional part view of the sheet feed unit 60 according to the second embodiment. In FIG. 4, the conveyance direction of the transfer sheet P is indicated by a dash-and-dot line. For convenience’ sake, the parts similar to those in the first embodiment described previously and shown in FIGS. 1 to 3 are identified by the same reference signs. In the second embodiment, the sheet feed unit 60 further has a guide member 73. In other respects, the structure here is similar to that in the first embodiment.

The guide member 73 is arranged on the conveyance face of the sheet conveyance passage 19 that connects together the pickup roller 62 and the guide rail 71 and supports the bottom face of the transfer sheet (recording medium) P. Arranging the guide member 73 allow smooth conveyance of the transfer sheet (recording medium) P from the pickup roller 62 to the nip portion between the pair of feeding rollers 63. This helps further reduce sheet feed failure.

The top face of the guide member 73 is configured with a grounded second charge elimination member 74. The second charge elimination member 74 is, for example, made of electrically conductive sheet metal and stainless steel (SUS material) is suitably used. The electric charge on the transfer sheet P electrostatically charged by friction with the feed roller 63a is eliminated via the second charge elimination member 74. This further reduces the amount of charge on the transfer sheet P passing through the feed roller 63a. Also, the charge current can be passed via the second charge elimination member 74, via a position away from the sheet conveyance passage 19. This prevents damage to circuit boards and sensors arranged near the sheet conveyance passage 19 and reduces operation failure in the apparatus.

The guide member 73 and the second charge elimination member 74 may be configured as one integral member or may be configured as separate members. For example, the guide member 73 may be configured as a molding of resin and a plate-form second charge elimination member 74 may be arranged on the top face of the guide member 73.

The width of the second charge elimination member 74 in the axial direction (Y1-Y2) is greater than the width of the nip portion between the feed roller 63a and the retard roller 63b in the axial direction (Y1-Y2). Thus, the electric charge on the electrostatically charged transfer sheet P can be efficiently eliminated via the second charge elimination member 74.

The second charge elimination member 74 is grounded via the main body frame of the image forming apparatus 100. Specifically, the second charge elimination member 74 and the main body frame of the image forming apparatus 100 are connected together via a wire spring, wire, conductive tape, or the like. The second charge elimination member 74 and the guide rail 71 may be connected together via a wire spring, wire, conductive tape, or the like.

The present disclosure is not limited to the above embodiment and can be carried out with any modifications made without departure from the spirit of the present disclosure. For example, in the above embodiment, the first charge elimination member is configured as the guide rail 71; instead, a plate-form member of stainless steel (SUS material) may be arranged in the housing 69 to serve as the first charge elimination member.

The present disclosure is applicable not only to color copiers but also to other vertical-conveyance type image forming apparatuses such as analog copiers, digital multifunction peripherals, monochrome and color printers, and facsimile machines.

What is claimed is:

1. An image forming apparatus, comprising:
an image forming portion that forms an image on a recording medium, and
a sheet feed unit that feeds the recording medium to the image forming portion,
wherein
the sheet feed unit includes:
a pickup roller that makes contact with the recording medium stored in a sheet feed cassette, the pickup roller feeding out the recording medium;
a feed roller that conveys the recording medium fed out by the pickup roller; and
a retard roller that is kept in pressed contact with the feed roller to form a nip portion, the retard roller conveying the recording medium while separating one sheet of it from the rest,
the feed roller is covered at least partly from above by a first charge elimination member, and
the first charge elimination member is grounded.

2. The image forming apparatus according to claim 1, wherein:
the feed roller and the first charge elimination member face each other across a gap of 2 mm or more but 4 mm or less.

3. The image forming apparatus according to claim 1, wherein:
the first charge elimination member has a length in an axial direction greater than an axial length of the feed roller.

4. The image forming apparatus according to claim 1, wherein:
the first charge elimination member curves along the feed roller to be convex outward in a radial direction.

5. The image forming apparatus according to claim 1, further comprising:
a housing that holds the pickup roller, the feed roller, and the retard roller,
wherein
the sheet feed unit is attachable to an apparatus main body along a guide rail arranged in the housing, and
the first charge elimination member is configured as the guide rail.

6. The image forming apparatus according to claim 1, wherein:
the sheet feed unit further comprises:
a guide member that is arranged on a conveyance face of a sheet conveyance passage that connects together the pickup roller and the feed roller, the guide member supporting a bottom face of the recording medium,
wherein
a top face of the guide member is configured with a second charge elimination member.

7. The image forming apparatus according to claim 6, wherein:
a width of the second charge elimination member in the axial direction is greater than a width of the nip portion.

8. The image forming apparatus according to claim 6, wherein:
the second charge elimination member is grounded.
